(19) United States
(12) Patent Application Publication
(10) Pub. No.: US 2024/0264012 A1
(43) Pub. Date: Aug. 8, 2024

(54) PIEZOELECTRIC POLYMER IMPACT DETECTOR

(71) Applicant: INTERLINK ELECTRONICS, INC., Irvine, CA (US)

(72) Inventors: Zhiyun CHEN, Camarillo, CA (US); Yen Ching LIM, Camarillo, CA (US); Kyung Tae PARK, Berwyn, PA (US)

(21) Appl. No.: 18/431,543

(22) Filed: Feb. 2, 2024

Related U.S. Application Data
(60) Provisional application No. 63/483,427, filed on Feb. 6, 2023.

(51) Int. Cl. G01L 1/16

(52) U.S. Cl. CPC G01L 1/16

(57) ABSTRACT

In an example, an impact detector may include a sensor mounting bracket, a piezo film sensor assembly, and an interface circuit. The sensor mounting bracket may be attached to an impact sensing object. The piezo film sensor assembly may be coupled to the sensor mounting bracket. The interface circuit may be configured to obtain one or more generated signals from the piezo film sensor assembly. The interface circuit may be configured to reduce a first amplitude associated with a noise signal and may be configured to amplify a second amplitude associated with an impact signal. The impact signal may occur in response to a force being applied to the impact sensing object.

### CROSS-REFERENCE TO RELATED APPLICATION

The application claims priority to U.S. Provisional Application Ser. No. 63/483,427, dated Feb. 6, 2023, the entire disclosure of which is incorporated herein in its entirety.

### FIELD

The embodiments discussed in the present disclosure are related to a piezoelectric polymer sensor device as an impact detector.

### BACKGROUND

Autonomous mobile devices, such as auto-driving vehicles, AI robots, and factory automation machines have become increasingly popular. Various sensors are implemented to avoid obstacles and to protect the autonomous mobile devices from collisions. There are increasing demands for the impact detectors to provide an additional line of protection in case such camera systems or proximity sensors fail to detect obstacles.

When an impact occurs to an object, the impact creates a mechanical vibration and thus a strain on the surface of the object structure. A strain sensor can be used to detect such an impact. As a strain sensor, traditional semiconductor strain gauges or foil gauges can be conceived but typically, those gauges are brittle and the coverage area is limited unless an array of such gauges are employed, which increases the cost and complexity. These strain gauges might not be suitable for some applications which may use high impact force sensing or wide coverage areas.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, an impact detector may include a sensor mounting bracket, a piezo film sensor assembly, and an interface circuit. The sensor mounting bracket may be attached to an impact sensing object. The piezo film sensor assembly may be coupled to the sensor mounting bracket. The interface circuit may be configured to obtain one or more generated signals from the piezo film sensor assembly. The interface circuit may be configured to reduce a first amplitude associated with a noise signal and may be configured to amplify a second amplitude associated with an impact signal. The impact signal may occur in response to a force being applied to the impact sensing object.

The object and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example piezo film impact detector, in accordance with one or more embodiment of the present disclosure;

FIG. 2 illustrates an example piezo film sensor assembly using four piezo film strip sensors, in accordance with one or more embodiment of the present disclosure;

FIG. 3 illustrates another example piezo film sensor assembly using two piezo film strip sensors, in accordance with one or more embodiment of the present disclosure;

FIG. 4 illustrates an example piezo film strip, in accordance with one or more embodiment of the present disclosure;

FIG. 5 illustrates a cross section view of piezo film polarity and electrode arrangements, in accordance with one or more embodiment of the present disclosure;

FIG. 6 illustrates cross section view of a first piezo film sensor assembly and electrical connections between four piezo film strip sensors included in the first piezo film sensor assembly, in accordance with one or more embodiment of the present disclosure;

FIG. 7 illustrates anisotropic sensitivity of a piezo film, in accordance with one or more embodiment of the present disclosure;

FIGS. 8A-8C illustrate a piezo film strip generating a positive going signal when the piezo film strip is stretched and a negative going signal when the piezo film strip is compressed, in accordance with one or more embodiment of the present disclosure;

FIGS. 9A-9C illustrate a basic principle of twist mode noise cancellation (common-mode-rejection) of a piezo film sensor assembly, in accordance with one or more embodiment of the present disclosure;

FIGS. 10A-10C illustrate a basic principle of the longitudinal vibration noise cancellation (common-mode-rejection) of a piezo film sensor assembly, in accordance with one or more embodiment of the present disclosure;

FIGS. 11A-11C illustrate a basic principle of the impact signal enhancement principle of the first piezo film sensor assembly when an external impact occurs, in accordance with one or more embodiment of the present disclosure;

FIGS. 12A and 12B illustrate a vibration noise cancellation effect and impact signal enhancement effect using an interface circuit, in accordance with one or more embodiment of the present disclosure;

FIG. 13A illustrates a charge mode equivalent circuit of a piezo film, in accordance with one or more embodiment of the present disclosure;

FIGS. 13B and 13C illustrate the vibration noise cancellation effect (common-mode-rejection) and the impact signal enhancement effect, in accordance with one or more embodiment of the present disclosure;

FIG. 14A illustrates a voltage mode equivalent circuit of a piezo film, in accordance with one or more embodiment of the present disclosure;

FIG. 14B illustrates the vibration noise cancellation effect (common-mode-rejection), in accordance with one or more embodiment of the present disclosure;

FIG. 14C illustrates a higher voltage amplitude from either piezo film detected by the voltage amplifier when an external impact occurs, in accordance with one or more embodiment of the present disclosure.

FIG. 15 illustrates a flowchart of an example method, in accordance with one or more embodiment of the present disclosure.

### DETAILED DESCRIPTION OF EMBODIMENTS

Piezoelectric polymer such as PVDF (also known as VF₂) or copolymer (also known as VF₂VF₃) is a thin (typically, 9 μm to 200 μm thick), light weight, flexible, and extremely robust polymer sensing material which can be used as a dynamic strain sensor. In the present disclosure, the word “piezo film” “piezo film strip” may be used to include both piezoelectric PVDF and copolymer for convenience. Piezo film sensor size and shape may be easily tailored to each application. To cover a wide impact zone, a narrow and long piezo film strip can be used, as an example, a 10 mm wide and 1-meter-long piezo film strip.

Piezo film may generate electrical charges or a voltage without an external power supply when a mechanical stress or strain is applied, and the output may be linearly proportional to the applied stress or strain. Piezo film may generate a positive going signal when stretched and a negative going signal when compressed, or vice versa depending on the interface circuit arrangement. Piezo film may have a high voltage sensitivity as a strain sensor and may be used to detect an impact on a surface of a mobile object. In some circumstances, when the mobile object is operated on an uneven surface, the mobile object may create a vibration on the surfaces of the mobile object and may generate an unwanted signal (e.g., vibration induced noise) on the piezo film. In general, the impact signal is much stronger than the vibration induced noise but to avoid detecting a false impact, it may be desirable to facilitate a lowest impact signal (e.g., such as, a small impact force) to satisfy a threshold greater than a worst-case vibration induced noise. Therefore, a means which can suppress the vibration induced noise and enhance the impact signal is desired. In the present disclosure, an innovative piezo film sensor assembly is disclosed which may suppress such vibration induced noise and may enhance the impact signal to increase the signal-to-noise ratio, and thus reduce the false impact detections.

At least one aspect of the present disclosure may include enhancing a signal-to-noise ratio by suppressing unwanted signals (i.e., noise) created by the environmental vibration and enhancing an impact signal output. To suppress the vibrational noise, common-more-rejection configurations using multiple piezo film sensors may be utilized along with an interface circuit. The impact detector may include a sensor mounting bracket, a piezoelectric polymer sensor assembly, a cover housing, and an interface circuit. The impact detector can be installed on a flat or a curved surface and may cover a wide impact zone. The impact detector may be installed on the inner surface of an impact sensing object, and may be replaceable. The impact detector may be environmentally protected and may also shielded from electromagnetic interference (EMI).

The impact detector may include a sensor mounting bracket made of a compliant material, such as rubber, a piezo film sensor assembly, a cover housing made of a flexible material, such as plastic, and an interface circuit. The impact detector may be flexible and may be installed on a flat or a curved surface. The impact detector also may be installed on an inner surface of an impact sensing object.

In some embodiments, the sensor mounting bracket may be attached on an inner surface of an impact sensing object. The piezo film sensor assembly may be inserted or disposed within an open slot included in the sensor mounting bracket and the piezo film sensor assembly may not be attached to the mounting bracket or the cover housing. In instances where the piezo film sensor assembly is not attached to the sensor mounting bracket or the cover housing, the piezo film sensor assembly may be free to move in-between the sensor mounting bracket and the cover housing. The piezo film sensor assembly may be replaced by simply opening the cover housing and pulling the piezo film sensor assembly out of the mounting bracket. The interface circuit may be located near by the piezo film sensor assembly, preferably near a sensor lead assembly area of the piezo film sensor assembly.

In some embodiments, a first piezo film sensor assembly may include four piezo film strips, a flexible center plate (typically, a plastic plate), and two closed cell foam layers. The first piezo film sensor assembly may have a mechanical neutral axis in the middle of the center plate. The four piezo film strips may be arranged symmetrically on both sides of the center plate which may cancel or reduce the noise created by a longitudinal vibration as well as by the twist mode vibration. The two closed cell foam layers may be attached on both outer sides of the four piezo film strips of the first piezo sensor assembly. Some of the purposes of the closed cell foams may include enhancing the impact signal, reducing vibration noise, and/or protecting the four piezo film strips.

A second piezo film sensor assembly may include two piezo film strips, a flexible center plate (typically, a plastic plate), and two closed cell foam layers. The second piezo film sensor assembly may have a mechanical neutral axis in the middle of the center plate. The two piezo film strips may be symmetrically arranged on both sides of the center plate which may reduce or cancel the noise created by a longitudinal vibration. The center plate may be reasonably thick so that vertical vibration and the twist mode vibration may be suppressed. The second piezo film sensor assembly may reduce sensor complexity and cost relative to the first piezo film sensor assembly. The two closed cell foam layers may be attached on both outer sides of the two piezo film strips of the second piezo sensor assembly. Some of the purposes of the closed cell foam layers may include enhancing the impact signal, reducing vibration noise, and/or protecting the piezo film strips.

As the piezo film sensor assembly (e.g., the first piezo film sensor assembly and/or the second piezo film sensor assembly) may not be attached to the rubber bracket or the cover housing, the piezo film sensor assembly may be free to move which may allow the neutral axis of the piezo film sensor assembly to be maintained in the middle of the center plate. When an environmental vibration occurs to an impact sensing object, the piezo film strips on both sides of the center plate may generate the same or similar amplitude but opposite polarity signals because the neutral axis may be in the middle of the piezo film sensor assembly. When an external impact occurs to the impact sensing object, the sensor mounting bracket may be pushed inward and thus the piezo film sensor assembly may be stretched. The stretching may cause some or all of the piezo film strips in the piezo film sensor assembly to be stretched and generate the same polarity signals. With an interface circuit, the vibration induced signals may be reduced and the impact signals may be summed. Therefore, the signal-to-noise ratio may be enhanced.

In the disclosure, three interface circuits are disclosed each of which may reduce the vibration signal and enhance the impact signal. A first interface circuit may include a combination of an inverting voltage amplifier, a non-inverting voltage amplifier, and a differential amplifier. A second interface circuit may include a charge amplifier. A third interface circuit may include a voltage amplifier.

Some of the advantages of the disclosed impact detector may include an enhanced signal-to-noise ratio, an ability to install on a flat or a curved surface, and/or a wide impact area coverage on the impact sensing object.

Embodiments of the present disclosure are explained with reference to the accompanying figures.

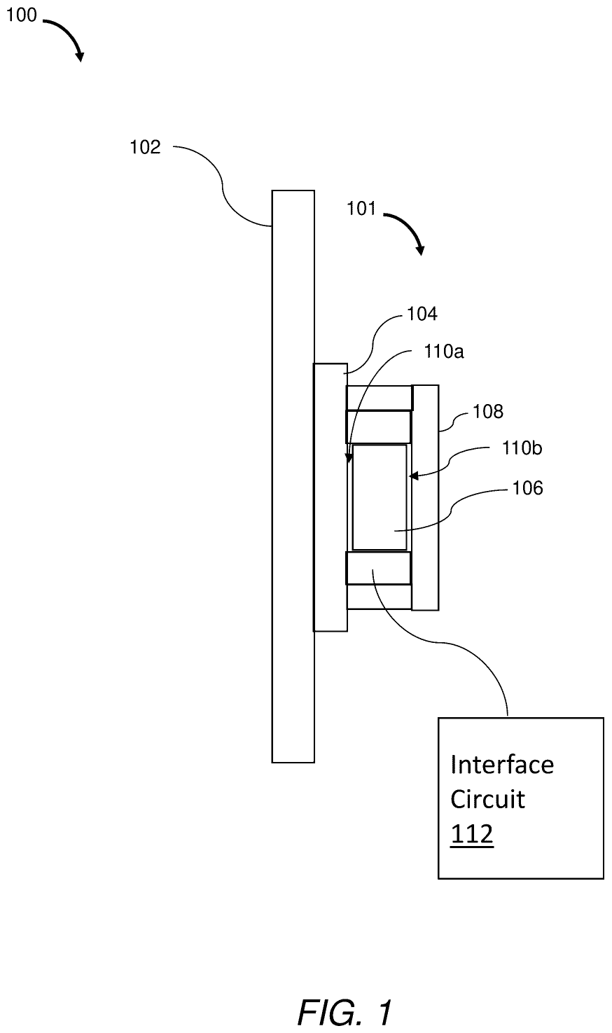

FIG. 1 illustrates an environment 100 that includes an example impact detector 101, in accordance with one or more embodiments of the present disclosure. In some embodiments, the impact detector 101 may include a sensor mounting bracket 104, a piezo film sensor assembly 106 (“sensor assembly 106”), a cover housing 108, and an interface circuit (not depicted).

In some embodiments, the impact detector 101 may be environmentally shielded from a harsh environment. For example, the impact detector 101 may be water resistant and/or waterproof. In another example, the impact detector 101 may be configured to resist dust and/or debris entering an interior portion of the impact detector 101, such as where the sensor assembly 106 may be disposed. As a result, the impact detector 101 may be used in situation where vibration or impact detection may be desired.

In some embodiments, the sensor mounting bracket 104 may be installed on the surface of an impact sensing object 102. The impact sensing object 102 may receive and deliver impact and/or vibration to the impact detector 101 through the sensor mount bracket 104. In some embodiments, the impact sensing object 102 may be a vehicle, machine, electronic device, medical equipment, or any other object for which vibrations of the object or an impact affecting the object may be detected. In these and other embodiments, the impact detector 101 may be attached to the side or some portion of the impact sensing object 102. For example, the impact detector 101 may be attached to the inside of a bumper, panel, or engine compartment of a vehicle. As another example, the impact detector 101 may be attached to the outside or inside panel of medical equipment.

In some embodiments, the sensor mounting bracket 104 may be made of material compliant to deliver the impact. For example, the sensor mounting bracket 104 may be made of a material to transfer the energy from an impact from the impact sensing object 102 to the impact detector 101. For example, the sensor mounting bracket 104 may be made of rubber.

In some embodiments, the sensor mounting bracket 104 may have an open slot configured for the sensor assembly 106 to be inserted for installation without using adhesives or glues. In these and other embodiments, all four sides of the sensor assembly 106 may not be directly secured to the sensor mounting bracket 104 such that the sensor assembly 106 may be free to move in response to receiving vibrations. For example, gaps 110a, and 110b, such as air gaps, may exist between the sensor assembly 106 and the sensor mounting bracket 104 and the cover housing 108. The gaps 110 may allow the sensor assembly 106 to move free when a vibration or impact occurs. Such freedom to move may allow the neutral axis of the sensor assembly 106 to be maintained in the middle of the sensor assembly 106 for the common-mode-rejection configuration (vibration noise cancellation). Note that the sensor assembly 106 may extend into and out of the page. Thus, the sensor assembly 106 may be coupled on the top edge and the bottom edge but not the side edges. Alternately or additionally, the sensor assembly 106 may be coupled on a front and back edge to the sensor mounting bracket 104 and/or the cover housing 108. For example, the sensor assembly 106 may be coupled to the front and back edge but not on the sides, top, or bottom edges. In these and other embodiments, the sensor assembly 106 may be mounted or coupled to the cover housing 108 and/or the mounting bracket 104 such that the sensor assembly 106 has a freedom of movement in a least one axis in a three-dimensional plane. For example, the sensor assembly 106 may have freedom of movement in the plane that extends horizontally in FIG. 1. Alternately or additionally, the sensor assembly 106 may have freedom of in the plane that extends vertically in FIG. 1. In these and other embodiments, the sensor assembly 106 may be coupled in the plane that extends in and out of FIG. 1.

In some embodiments, the sensor assembly 106 may be replaceable. For example, after detecting an impact, the sensor assembly 106 may be damaged and may be replaced with another piezo film sensor assembly. In some embodiments, the replacement sensor assembly may be disposed within the sensor mounting bracket 104 that may be attached to the impact sensing object 102. Alternatively, the sensor assembly 106 may be disposed within a replacement sensor mounting bracket that may be attached to the impact sensing object 102.

In some embodiments, the cover housing 108 may be made of a flexible material. For example, the cover housing 108 may be made of flexible plastic or rubber. In instances in which the cover housing 108 is flexible, the impact detector 101 may be installed on a curved body of the impact sensing object 102.

In some embodiments, the cover housing 108 may have a locking mechanism configured to secure the sensor assembly 106 inside of the sensor mounting bracket 104 without using adhesives or glue for easy piezo film sensor assembly installation and/or replacement.

In some embodiments, the sensor assembly 106 may include one or more different configurations. For example, configurations corresponding to a first piezo film sensor assembly and a second piezo film sensor assembly may be disclosed. The first piezo film sensor assembly may include four piezo film strip sensors and may be capable of cancelling a longitudinal vibration noise as well as the twist mode vibration noise. The longitudinal noise vibration may be a vibration that occurs in the longitudinal axis which would extend into and out of the FIG. 1. The first piezo film sensor assembly may also enhance the impact signals detected by the impact detector. The second piezo film sensor assembly may include two piezo film strip sensors and may be capable of cancelling a longitudinal vibration noise. The second piezo film sensor assembly may enhance the impact signals detected by the impact detector.

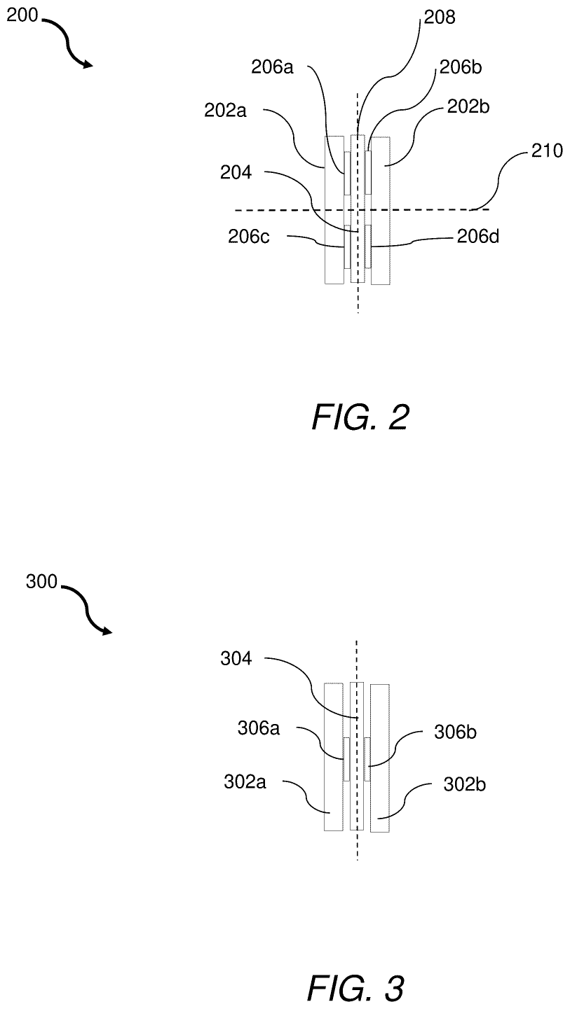

FIG. 2 illustrates an example piezo film sensor assembly 200 (“sensor assembly 200”), in accordance with one or more embodiments of the present disclosure. In some embodiments, the sensor assembly 200 may include four piezo film strips. For example, the sensor assembly 200 may include a first piezo film strip 206a, a second piezo film strip 206b, a third piezo film strip 206c, and a fourth piezo film strip 206d, which may collectively be referred to as the piezo film strips 206. In some embodiments, the sensor assembly 200 may include a flexible center plate 208, a first closed cell foam layer 202a, and a second closed cell foam layer 202b. In some embodiments, the closed cell foam layers 202 may be optional. Without the closed cell foam layers, the impact detector may provide the vibration noise cancellation effect as described herein. In some embodiments, the sensor assembly 200 that includes the closed cell foam layers 202 may further improve the signal-to noise ratio output by the sensor assembly 200.

In some embodiments, the sensor assembly 200 may be symmetric such that the neutral axis of the sensor assembly 200 may be in the middle of the center plate 208. In these and other embodiments, the piezo film strips 206 may be attached on each side of the center plate 208 using a pressure sensitive adhesive and/or other bonding media. In these and other embodiments, two sets of piezo film strips on opposite sides of the center plate 208 may be symmetric to the neutral axis of the center plate 208. The two sets of piezo film strips on each side of the center plate 208 may be symmetric to the horizontal center line.

In some embodiments, the symmetric four piezo film strips 206 may be used for one or more functions of the sensor assembly 200. For example, the piezo film strips 206 may be used for common-mode-rejection to reduce or cancel unwanted longitudinal vibration noise and/or twist mode vibration noise detected by the sensor assembly 200. As another example, the symmetric four piezo film strips 206 may be used for EMI shielding. As yet another example, the symmetric four piezo film strips 206 may be used for impact signal enhancement.

In some embodiments, the center plate 208 may be made of flexible materials such as plastic. In some embodiments, the center plate 208 may be reasonably thick to suppress the vibration. An example thickness of the center plate may be thicker than 0.1 mm and thinner than 5 mm.

In some embodiments, the closed cell foam layers 202 may be attached on outer sides of piezo film strips 206. For instance, the first closed cell foam layer 202a may be attached to the first piezo film strip 206a and the third piezo film strip 202c, and the second closed cell foam layer 202b may be attached to the second piezo film strip 206b and the fourth piezo film strip 206d. In some embodiments, the closed cell foam layers 202 may be attached to the respective piezo film strips using a pressure sensitive adhesive and/or any other suitable media.

In some embodiments, the closed cell foam layers 202 may be optional. For instance, the sensor assembly 200 may be assembled without the closed cell foam layers 202 and still provide an improved signal-to-noise ratio.

The closed cell foam layers 202 may further suppress vibration noise detected by the sensor assembly 200. When an external impact occurs, the external impact may push the sensor assembly 200 further away from the impact surface so that the piezo film strips 206 may be stretched more, and thus, higher amplitude signals may be generated by the piezo film strips 206 in response to the impact. In some embodiments, the closed cell foam layers 202 may be thicker than 1 mm and thinner than 10 mm.

FIG. 3 illustrates another example piezo film sensor assembly 300, in accordance with one or more embodiments of the present disclosure. In some embodiments, the sensor assembly 300 may include a first piezo film strip 306a, a second piezo film strip 306b, a center plate 304, a first closed cell foam layer 302a, and a second closed cell foam layer 302b. In some embodiments, the closed cell foam layers 302 may be optional. Without the closed cell foam layers 302, a piezo film impact detector including the sensor assembly 300 may provide the vibration noise cancellation effect as described herein. In some embodiments, the sensor assembly 300 that includes the closed cell foam layers 302 may further improve the signal-to noise ratio output by the sensor assembly 300.

In some embodiments, the sensor assembly 300 may be symmetric such that the neutral axis of the sensor assembly 300 may be in the middle of the center plate 304. In these and other embodiments, the first piezo film strip 306a and the second piezo film strip 306b may be placed on sides of the center plate 304 such that the first piezo film strip 306a and the second piezo film strip 306b may be placed symmetric with respect to the neutral axis of the center plate 304. In some embodiments, the piezo film strips 306 may be attached to the center plate 304 using a pressure sensitive adhesive and/or other bonding media. In some embodiments, the symmetric two piezo film strips 306 may be used for common-mode-rejection to cancel the unwanted longitudinal vibration noise detected by the sensor assembly 300.

The symmetric piezo film strips 306 may be used for one or more different functions. For example, the piezo film strips 306 may be used for EMI shielding. As another example, symmetric two piezo film strips 306 may be used for impact signal enhancement. In some embodiments, the center plate 304 may be made of a plastic. In some embodiments, the center plate 304 may be reasonably thick to suppress the vibration. An example thickness of the center plate 304 may be thicker than 0.1 mm and thinner than 5.0 mm.

In some embodiments, the closed cell foam layers 302 may be attached on both outer sides of piezo film strips 306 using a pressure sensitive adhesive and/or other media. In these and other embodiments, the closed cell foam layers 302 may be optional. The sensor assembly 300 without the closed cell foam layers 302 may still provide an improved signal-to-noise ratio. The closed cell foam layers 302 may further suppress the vibration noise detected by the sensor assembly 300. When an external impact occurs, the external impact may push the sensor assembly 300 further away from the impact surface so that the piezo film strips 306 may be stretched more, and thus, higher amplitude signals may be generated. In some embodiments, the closed cell foam layers 302 may be thicker than 1 mm and thinner than 10.0 mm.

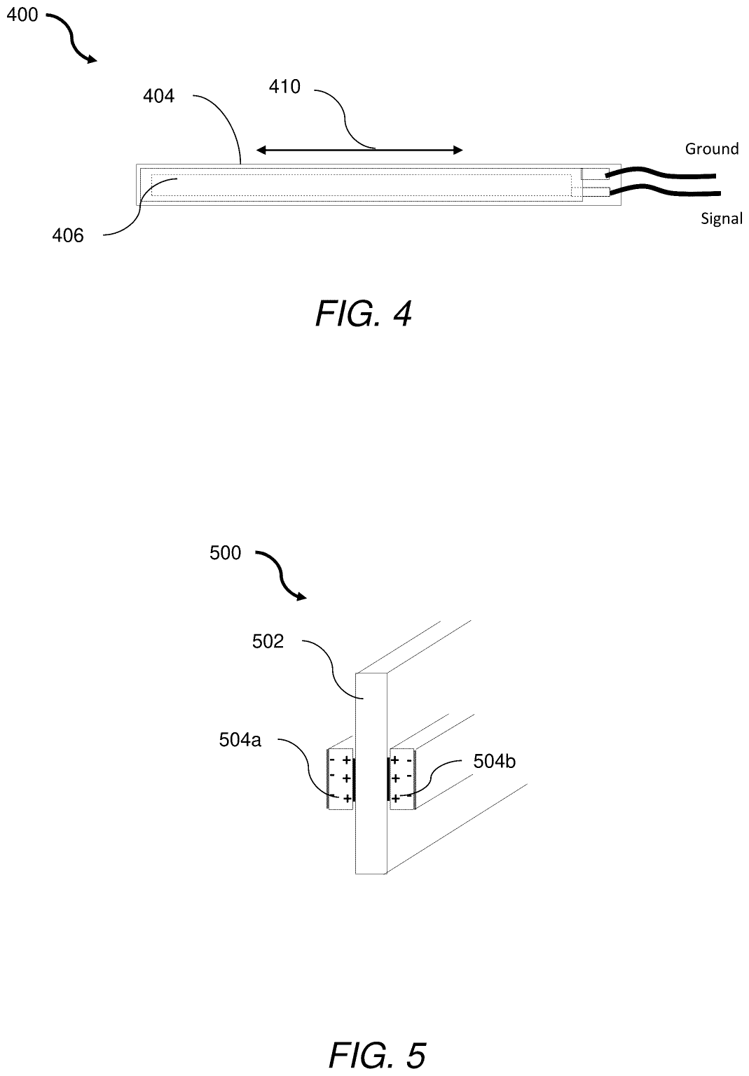

FIG. 4 illustrates an example piezo film strip 400, in accordance with one or more embodiments of the present disclosure. In some embodiments, the piezo film strip 400 may be made of either PVDF (also called VF₂) or copolymer (also called VF₂VF₃). In some embodiments, the piezo film strip 400 may be thicker than 5 um and thinner than 250 um. The piezo film strip may be used with the sensor assembly 200 of FIG. 2 and/or the sensor assembly 300 of FIG. 3.

With respect to the sensor assembly 200, the piezo film strip 400 may correspond to one or more of the piezo film strips 206. In these and other embodiments, the piezo film strips 206 may have the same, or nearly the same thickness. With respect to the sensor assembly 300, the piezo film strip 400 may correspond to the one or more of the piezo film strips 306. In these and other embodiments, the two piezo film strips 306 may have the same, or nearly the same thickness.

In some embodiments, the piezo film strip 400 may be polarized where one side of the piezo film strip 400 is positive and the other side of the piezo film strip 400 is negative. The piezo film strip 400 may have electrodes on both sides. For example, a positive electrode 406 may be on one side and a negative electrode 404 may be on another side. An electrode may include a printed silver ink, a carbon ink, or a sputtered electrode such as Au, Ag, Al, Cu, or ITO. In some embodiments, the negative electrode 404 may be larger than the positive electrode 406 for EMI shielding purposes.

In some embodiments, the piezo film strip 400 may be laminated on one side or both sides using a thin plastic film such as 125 um thick polyethylene terephthalate (PET) film for protection purposes, such as from the environment and/or handling. Alternatively, the piezo film strip 400 may be used without lamination layers.

In some embodiments, the negative electrodes 404 may include outer side electrodes of the piezo film strip 400, and the positive electrodes 406 of the piezo film strip 400 may include inner side electrodes. FIG. 4 further illustrates the longitudinal direction 410 of the piezo film strip 400. For example, a first end of the piezo film strip 400 may be illustrated in FIGS. 1, 2, and 3 and the longitudinal length of the piezo film strip 400 would extend into the page in FIGS. 1, 2, and 3. The piezo film strip 400 may be thicker than 5 micrometers but thinner than 250 micrometers. In these and other embodiments, the piezo film strip 400 may be any length. For example, the piezo film strip 400 may by 1 cm, 20 cm, 50 cm, 100 cm, 2 m, 3 m, or longer.

As an example, FIG. 5 illustrates an end of a piezo film strip 500 that extends into a page. The piezo film strip 500 includes an example piezo film strips 504 attached to a center plate 502. In some embodiments, the inner side (e.g., the side adjacent to the center plate 502) electrodes of the piezo film strips 504 may be adjacent to and/or in contact with the center plate 502 and the outer side electrodes of the particular piezo film strips 504 may be opposite the inner side electrodes and/or may be distant from the center plate 502.

In these and other embodiments, the outer side electrodes (e.g., the negative electrodes) may be electrically connected and/or grounded to the interface circuit for electromagnetic interference (EMI) shielding purposes. In some embodiments, the inner side electrodes (e.g., the positive electrodes) may be smaller than the outer side electrodes for EMI shielding purposes. This configuration of piezo films may also assist in vibration induced noise cancellation.

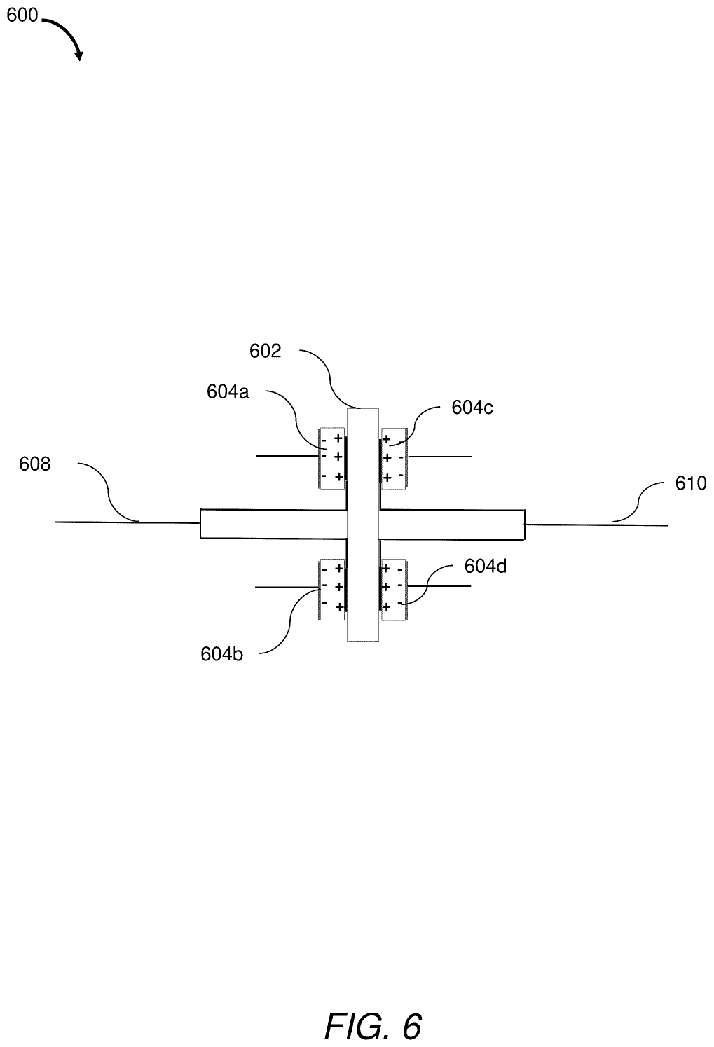

FIG. 6 illustrates an example arrangement 600 of the polarities associated with the piezo film strips 604 and/or electrical connections between the piezo film strips 604. In some embodiments, the arrangement 600 may correspond to how the piezo film strips 206 are arranged in FIG. 2.

In some embodiments, inner side electrodes may be smaller than the outer side electrodes for EMI shielding purposes. All outer side electrodes may be connected to the interface circuit ground.

In some embodiments, outputs from a first piezo film strip 604a and a second piezo film strip 604b may be connected to a first piezo film strip output 608, and outputs from a third piezo film strip 604c and a fourth piezo film strip 604d may be connected to a second piezo film strip output 610.

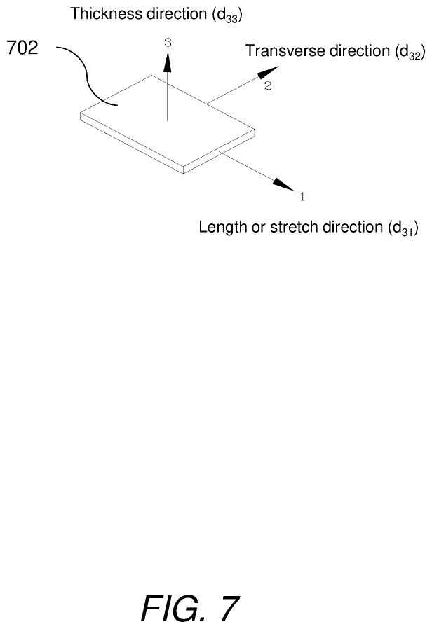

FIG. 7 illustrates anisotropic sensitivity of a piezo film strip 702. In some embodiments, the strain constants d₃₁, d₃₂, and d₃₃ of the piezo film strip 702 may indicate the charge sensitivity to the applied strain in first, second, and third directions, respectively.

Length direction strain sensitivity, d₃₁, may be greater than the transverse sensitivity, d₃₂. Therefore, the length direction of a piezo film strip may be aligned to the first direction of a piezo film strip as shown in FIG. 7.

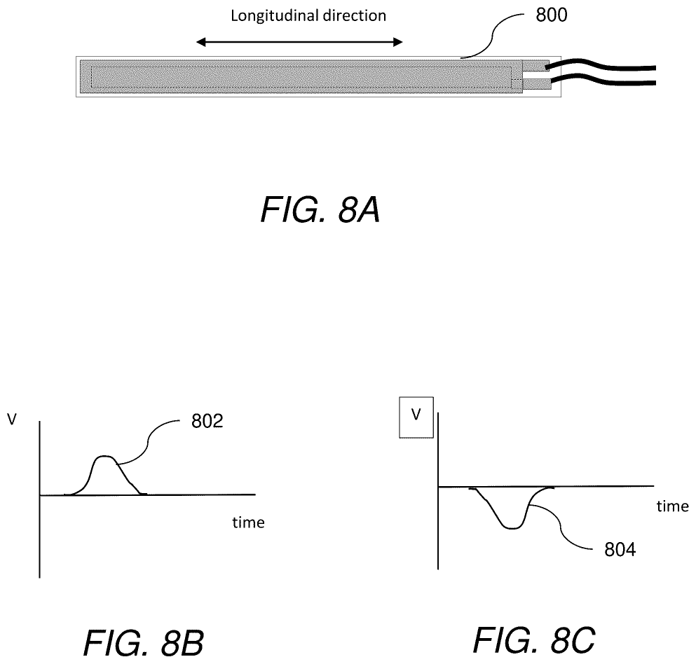

FIGS. 8A-8C illustrate a piezo film strip 800 generating signals. The piezo film strip 800 may be stretched and/or compressed. FIG. 8B illustrates a first signal 802 representing positive going signal when the piezo film strip 800 is stretched. FIG. 8C illustrates a second signal 804 representing a negative going signal when the piezo film strip 800 is compressed. In some embodiments, the first signal 802 and the second signal 804 may include amplitudes proportional to the applied strain (e.g., stretch or compression).

In some embodiments, the piezo film strip 800 may generate a positive going signal when the piezo film is stretched and a negative going signal when the piezo film is compressed or vice versa depends on the interface circuit. The twist mode vibration noise can be cancelled with the first piezo film sensor assembly.

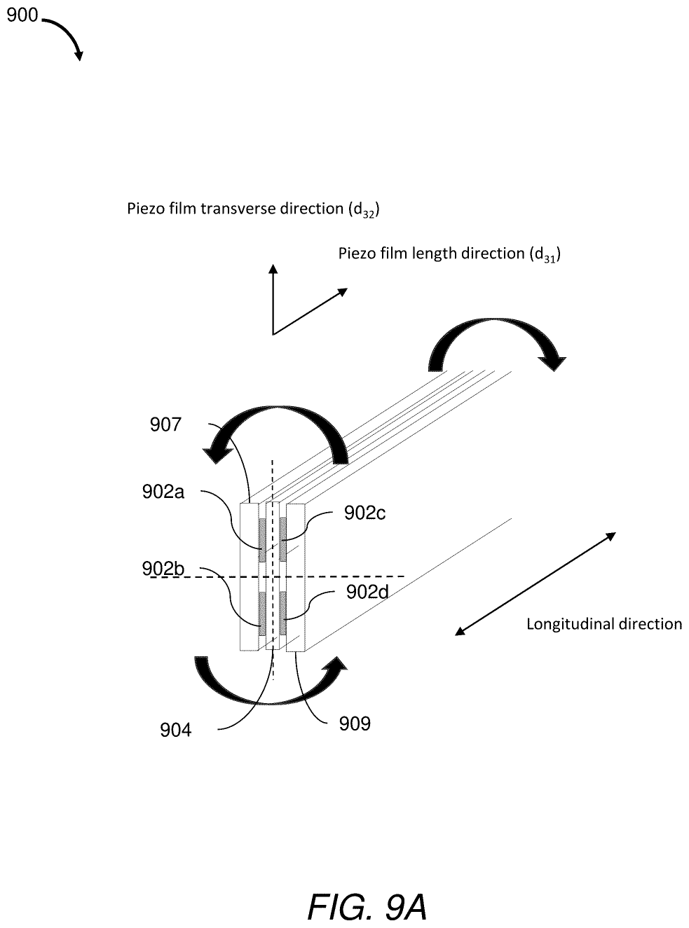

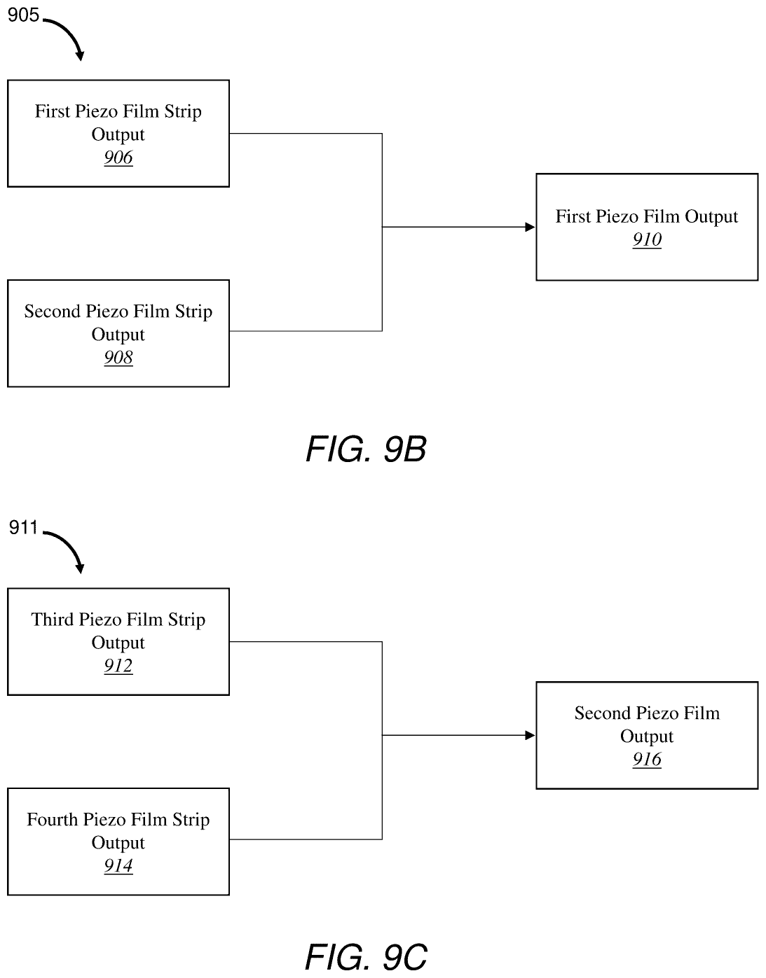

FIG. 9A illustrates an example sensor assembly 900, in accordance with one or more embodiments of the present disclosure. In some embodiments, the sensor assembly 900 may include a first piezo film strip 902a, a second piezo film strip 902b, a third piezo film strip 902c, and a fourth piezo film strip 902d attached to a center plate 904. A first closed cell foam layer 907 and a second closed cell foam layer 909 may be attached to the piezo film strips 902. For example, the first closed cell foam layer 907 may be attached to the first piezo film strip 902a and the second piezo film strip 902b, and the second closed cell foam layer 909 may be attached to the third piezo film strip 902c and the fourth piezo film strip 902d.

In instances in which a twist mode vibration occurs, the first piezo film strip 902a and the fourth piezo film strip 902d may be compressed and the second piezo film strip 902b and the third piezo film strip 902c may be stretched in the transverse direction, d₃₂. Therefore, the first piezo film strip 902a and the fourth piezo film strip 902d may generate negative going signals, and the second piezo film strip 902b and the third piezo film strip 902c may generate positive going signals. In these and other embodiments, as the piezo film strips 902 are symmetric to the neutral axis and the horizontal center line, amplitudes of all signals generated by the piezo film strips may be the same.

In these and other embodiments, the twist mode violation noise may be cancelled by combining outputs from opposite piezo film strips 902. For example, FIG. 9B illustrates a first piezo film strip output 906 associated with a first piezo film strip 902a being combined with a second piezo film strip output 908 associated with a second piezo film strip 902b to form a first piezo film output 910. In these and other embodiments, the first piezo film output 910 may be such that the twist mode vibration noise is cancelled.

FIG. 9C illustrates a third piezo film strip output 912 associated with a third piezo film strip 902c being combined with a fourth piezo film strip output 914 associated with a fourth piezo film strip 902d to form a second piezo film output 916. In these and other embodiments, the first piezo film strip output 906 may be such that the twist mode vibration noise is cancelled.

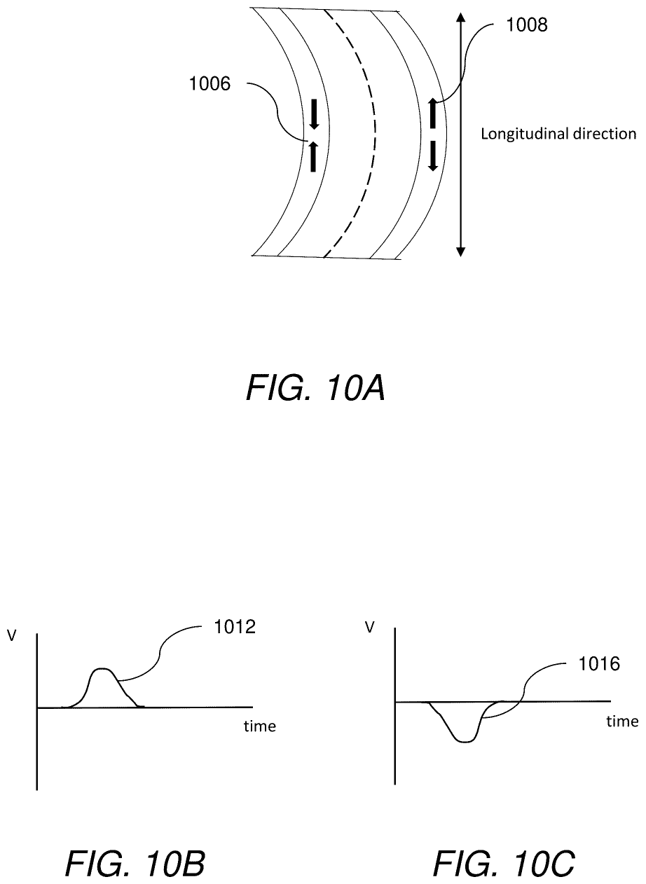

When a longitudinal vibration occurs, as shown in FIG. 10A, the first piezo film strip 902a and the second piezo film strip 902b of FIG. 9A may be compressed in a first direction 1006 and the third piezo film strip 902c and the fourth piezo film strip 902d of FIG. 9A may be stretched in a second direction 1008. Therefore, the first piezo film strip 902a and the second piezo film strip 902b may generate negative going signals as illustrated by a first signal 1012 of FIG. 10B, and the third piezo film strip 902c and the fourth piezo film strip 902d may generate positive going signals as illustrated by a second signal 1016 of FIG. 10C.

In some embodiments, as all four of the piezo film strips (e.g., the first piezo film strip 902a and the second piezo film strip 902b, the third piezo film strip 902c and the fourth piezo film strip 902d of FIG. 9A) may be symmetric to the neutral axis and the horizontal center line, amplitudes of all signals from the four piezo film strips may be the same or similar.

In these and other embodiments, the first piezo film strip 902a and the second piezo film strip 902b may be connected to the first piezo film strip output 906 and the third piezo film strip 902c and the fourth piezo film strip 902d may be connected to the second piezo film strip output 908, as shown in FIGS. 9B-9C. The first piezo film strip output 906 and the second piezo film strip output 908 caused by a vibration may be cancelled or reduced using one or more arrangements of the interface circuit. The impact signal generated by the piezo film strips may be summed with the first piezo film sensor assembly.

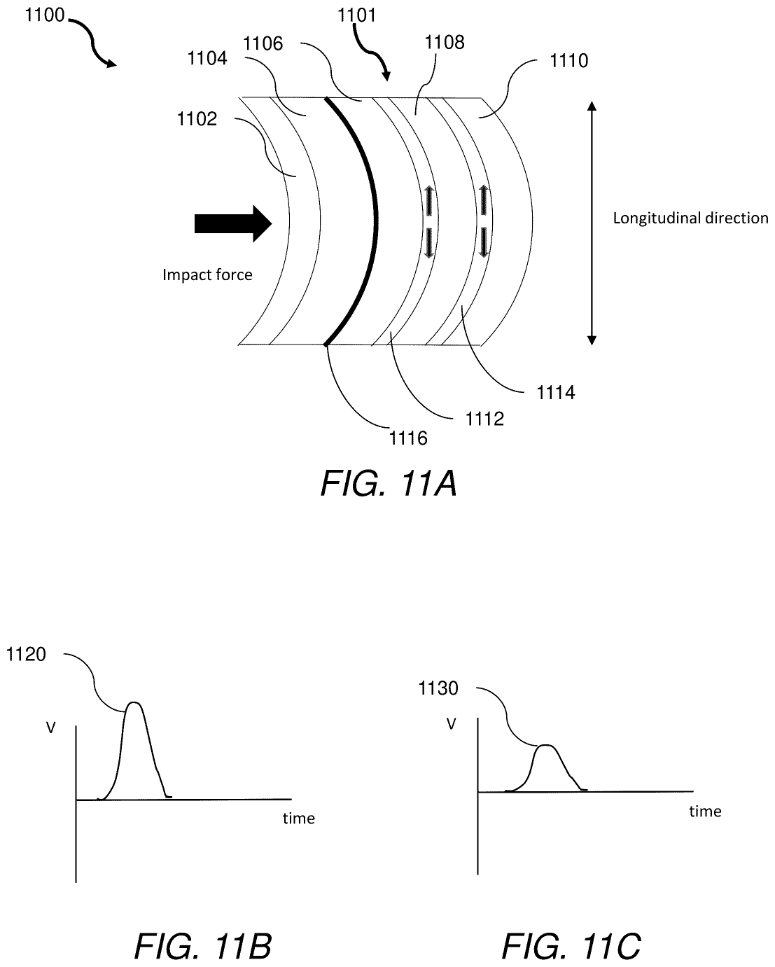

When an external impact occurs to the impact sensing object, the sensor mounting bracket may push the piezo film sensor assembly inward and thus, all four piezo film strips (e.g., the piezo film strips 902 of FIG. 9A) may be stretched. Such an example is shown in FIG. 11A. FIG. 11A illustrates a top view of an example impact detector 1100. In some embodiments, the impact detector 1100 may include an object body 1102, a bracket 1104, and sensor assembly 1101 that includes a first closed cell foam layer 1106, a first set of piezo film strips 1112 (including a first piezo film strip and a second piezo film strip), a center plate 1108, a second set of piezo film strips 1114 (including a third piezo film strip and a fourth piezo film strip), and a second closed cell foam layer 1110. Note that a gap 1116 exists between the bracket 1104 and the sensor assembly 1101 such that there is a gap between the bracket 1104 and the first closed cell foam layer 1106. A similar gap may exist between the second closed cell foam layer 1110 and a cover housing that may surround the sensor assembly 1101 but is not illustrated. The bracket 1104 may be flexible such that the bracket 1104 conforms to the object body 1102 and maintains the gap between the bracket 1104 and the sensor assembly 1101 when an impact force is applied to the object body 1102. As such, the film strips 1112 and the 1114 may freely contract and/or expand along the proper axis as the bracket 1104 and the housing expand in an axis perpendicular to the longitudinal direction of the sensor assembly 1101 to measure the force of the impact.

In response to receiving impact force on the object body 1102, the impact detector 1100 may be pushed inward, in which the first set of piezo film strips 1112 and the second set of piezo film strips 1114 may all be stretched. In these and other embodiments, the piezo film strips may generate the same polarity signals. In these and other embodiments, the third piezo film strip and the fourth piezo film strip may be stretched more than the first piezo film strip and the second piezo film strip.

FIG. 11B illustrates first output signals 1120 generated by the third piezo film strip and the fourth piezo film strip, and FIG. 11C illustrates second output signals 1130 generated by the first piezo film strip and the second piezo film strip. In such instances, the first output signals 1120 may generate higher amplitude signals compared to the second output signals 1130, as shown in FIGS. 11B and 11C.

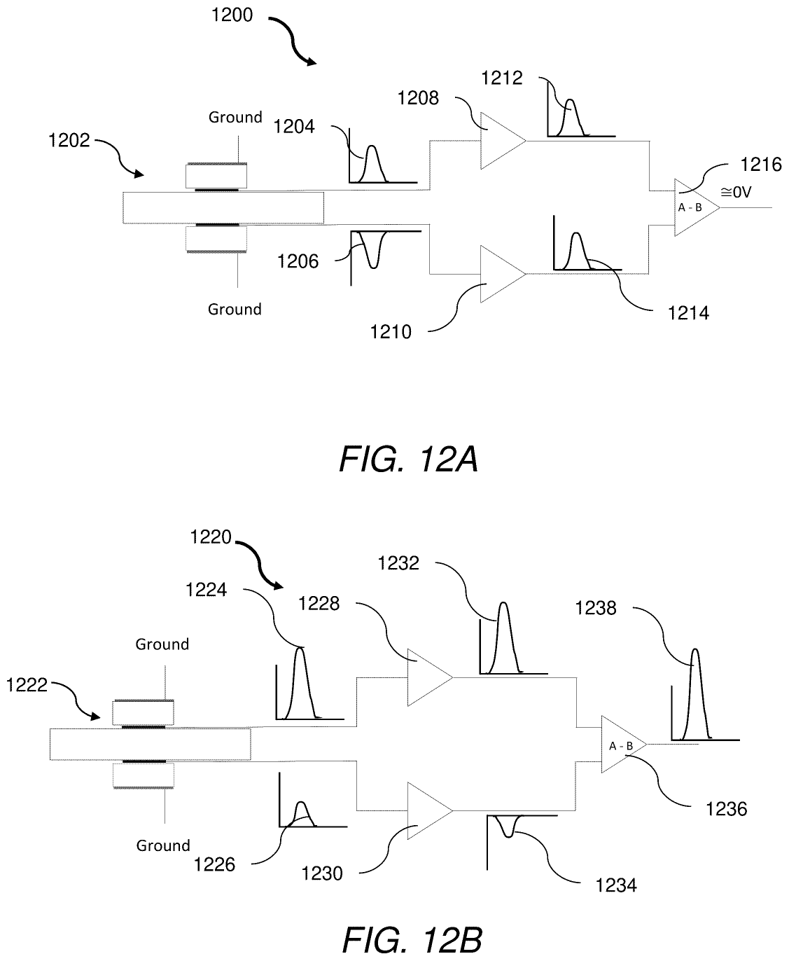

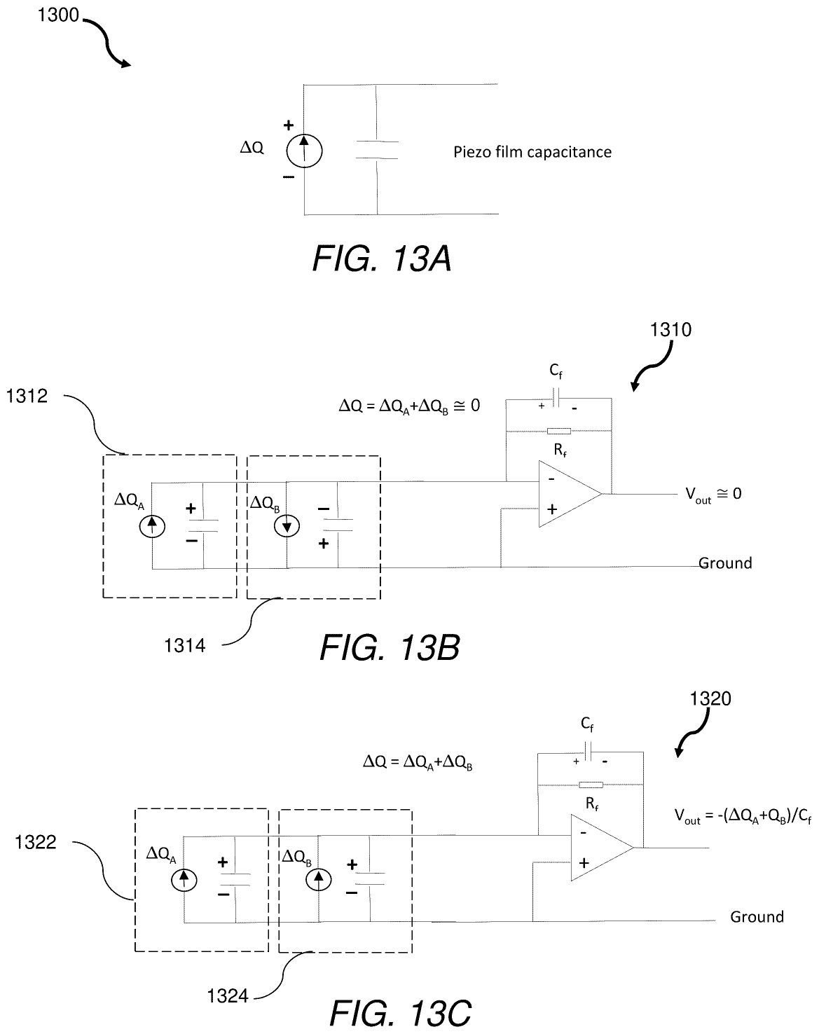

In some embodiments, the four piezo film strip outputs (e.g., the first piezo film strip output 906, the second piezo film strip output 908, the third piezo film strip output 912, and the fourth piezo film strip output 914 of FIGS. 9B-9C) generated by an external impact can be either summed or the highest amplitude voltage output can be detected using one or more arrangements of the interface circuit. An interface circuit may be employed to enhance the signal-to-noise ratio. For example, the interface circuit may include one or more circuit components configured to compare signals output by the piezo film strips to increase the signal-to-noise ratio of the sensor assembly. An example of an interface circuit is provided with respect to FIGS. 12A, 12B, 13A, 13B, and 13C.

FIG. 12A illustrates an example interface circuit 1200, in accordance with one or more embodiments of the present disclosure. In some embodiments, the interface circuit 1200 may be configured to enhance the signal-to-noise ratio. In some embodiments, the interface circuit 1200 may include an inverting voltage amplifier 1210, a non-inverting voltage amplifier 1208, and a differential amplifier 1216. The interface circuit 1200 may be coupled to the sensor assembly 1202. In some embodiments, the interface circuit 1200 may be configured to cancel the vibration noise and/or may sum the impact signals generated by the sensor assembly 1202. Therefore, the interface circuit 1200 may further enhance the signal-to-noise ratio of signals generated by the sensor assembly 1202.

For example, a first piezo film strip output 1204 may be connected to the non-inverting voltage amplifier 1208 and a second piezo film strip output 1206 may be connected to the inverting voltage amplifier 1210, or vice versa. A first output 1212 from the non-inverting voltage amplifier 1208 and a second output 1214 from the inverting voltage amplifier 1210 may be fed to the differential amplifier 1216.

In instances in which a longitudinal vibration occurs to the impact sensing object, and thus subsequently, to the sensor assembly, the first piezo film strip output 1204 and the second piezo film strip output 1206 may have the same amplitude signals but the opposite polarities because a neutral axis is in the middle of a center plate of the sensor assembly 1202. As the first piezo film strip output 1204 and the second piezo film strip output 1206 are connected to a non-inverting voltage amplifier and an inverting voltage amplifier, respectively, the first piezo film strip output 1204 and the second piezo film strip output 1206 may have the same polarity and the same amplitude signals (e.g., the first output 1212 and the second output 1214) when provided to the differential amplifier 1216. Thus, when the first output 1212 and the second output 1214 are fed to the differential amplifier 1216, the output of the differential amplifier 1216 may become zero or approximately zero. Therefore, the first piezo film strip output 1204 and the second piezo film strip output 1206 created by the longitudinal vibration may be cancelled (common-mode-rejection). In some embodiments, one or more other first piezo film strip outputs and/or one or more other second piezo film strip outputs may be coupled to other amplifiers and provided to the differential amplifier 1216.

FIG. 12B illustrates another example interface circuit 1220, in accordance with one or more embodiments of the present disclosure. In some embodiments, the interface circuit 1220 may be configured to enhance the signal-to-noise ratio, e.g. the strength of a signal indicating an impact as compared to the strength of a signal indicating vibrations or other noise inducing forces or waves. In some embodiments, the interface circuit 1220 may include piezo film strips 1222, an inverting voltage amplifier 1230, a non-inverting voltage amplifier 1228, and a differential amplifier 1236. In some embodiments, the interface circuit 1220 may be configured to cancel the vibration noise and/or may sum the impact signals generated by the piezo film strips 1222. Therefore, the interface circuit 1220 may further enhance the signal-to-noise ratio.

When an impact occurs to the impact sensing object, a surface of the impact sensing object may be pushed inward and thus the sensor mounting bracket pushes the first piezo film sensor assembly inward and thus all four piezo film strips may be stretched. Therefore, all four piezo film strips may generate the same polarity signals. As the outer side piezo film strips, may be stretched more than the inner piezo film strips, a first piezo film strip output 1224 may have a higher amplitude signal than a second piezo film strip output 1226. When the first piezo film strip output 1224 and the second piezo film strip output 1226 are fed to the non-inverting voltage amplifier 1228 and the inverting voltage amplifier 1230, respectively, the first piezo film strip output 1224 and the second piezo film strip output 1226 may become opposite polarity signals. When a first output 1232 from the non-inverting voltage amplifier 1228 and a second output 1234 from the inverting voltage amplifier 1230 are fed to the differential amplifier 1236, the first output 1232 and the second output 1234 may be summed. As a result, the longitudinal vibration induced signals (e.g., noise) may be cancelled and the impact signals may be summed, thus the signal-to-noise ratio may be enhanced. In some embodiments, one or more other first piezo film strip outputs and/or one or more other second piezo film strip outputs may be coupled to other amplifiers and provided to the differential amplifier 1236.

In some embodiments, an interface circuit 1220 may include a charge amplifier. The interface circuit 1220 may cancel the vibration noise and/or may sum the impact signals using a charge amplifier. Therefore, the interface circuit 1220 may further enhance the signal-to-noise ratio.

FIG. 13A illustrates a charge mode equivalent circuit 1300 corresponding to a piezo film strip, in accordance with one or more embodiments of the present disclosure. In some embodiments, the charge mode equivalent circuit 1300 may include an internal charge generator and a parallel capacitance. The charge generated by the charge mode equivalent circuit 1300 may be proportional to the applied strain to a piezo film strip. The charge mode equivalent circuit 1300 may demonstrate the electrical behavior of a sensor assembly but does not illustrate the electrical components of a sensor assembly.

FIG. 13B illustrates an amplifier 1310 configured to cancel vibration noise, in accordance with one or more embodiments of the present disclosure. In some embodiments, the amplifier 1310 may include coupled to two charge mode equivalent circuits (e.g., the charge mode equivalent circuit 1300 of FIG. 13A). For example, a first charge mode equivalent circuit 1312 may generate a first piezo film strip output (e.g., the first piezo film strip output 1204 of FIG. 12A) and a second charge mode equivalent circuit 1314 may generate a second piezo film strip output (e.g., the second piezo film strip output 1206 of FIG. 12A).

When a longitudinal vibration occurs to the impact sensing object and thus subsequently to the piezo film sensor assembly, the first piezo film strip output and the second piezo film strip output may generate the same, or approximately the same amount of electrical charge but may have opposite polarities because the neutral axis is in the middle of the center plate. As the first piezo film strip output and the second piezo film strip output are connected to each other, the charges may be cancelled and thus the output may become substantially zero.

FIG. 13C illustrates another example amplifier 1320, in accordance with one or more embodiments of the present disclosure. When an impact occurs to the impact sensing object, all piezo film strips may generate the same polarity charges. These electrical charges generated from the piezo film strips may be summed thru the charge amplifier, as illustrated in FIG. 13C.

For example, a first charge mode equivalent circuit 1322 may generate a first piezo film strip output (e.g., the first piezo film strip output 1224 of FIG. 12B) and a second charge mode equivalent circuit 1324 may generate a second piezo film strip output (e.g., the second piezo film strip output 1226 of FIG. 12B). As the first piezo film strip output and the second piezo film strip output have the same polarities, the first piezo film strip output and the second piezo film strip output may be summed. Accordingly, the longitudinal vibration noise may be cancelled but the impact signals may be summed, which may enhance the signal-to-noise ratio.

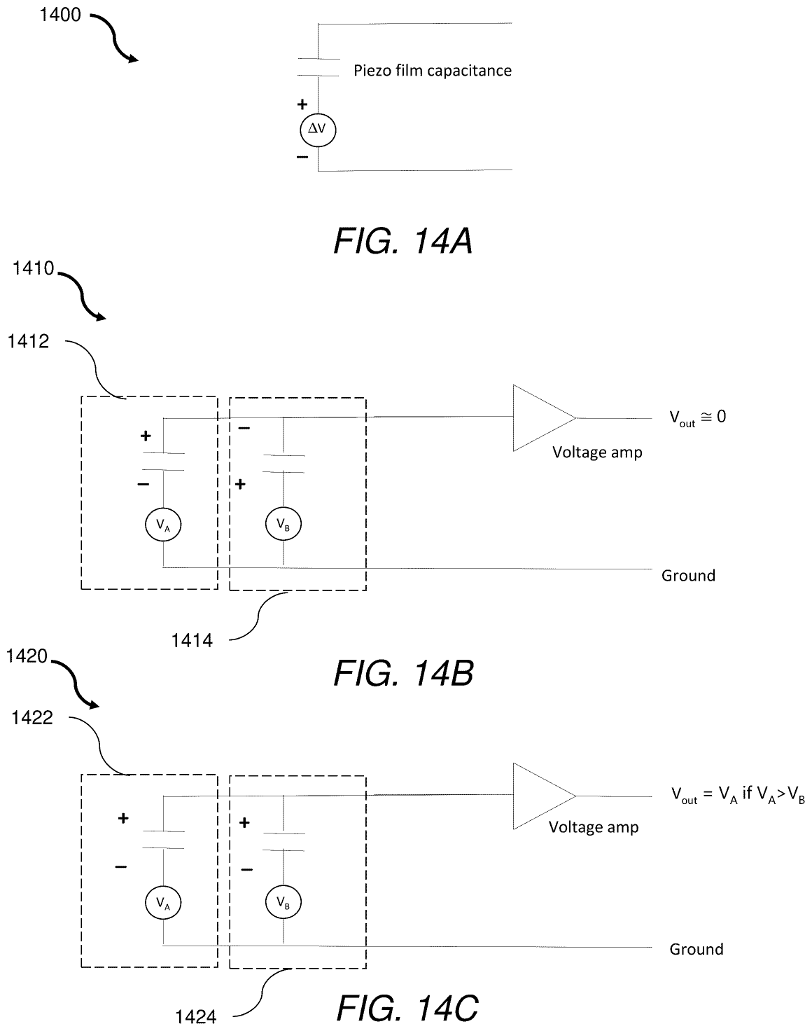

FIGS. 14A-14C illustrate example equivalent circuits, in accordance with one or more embodiments of the present disclosure. In some embodiments, the equivalent circuits may illustrate an equivalent circuit of a sensor assemble. In short, the equivalent circuits may demonstrate the electrical behavior of a sensor assembly, but do not illustrate the electrical components of a sensor assembly. For example, FIG. 14A illustrates an example equivalent circuit 1400. The equivalent circuit 1400 may be an equivalent of a piezo film strip that may include an internal voltage generator and a series capacitance. The generated voltage may be proportional to the applied strain to a piezo film strip.

In some embodiments, the equivalent circuit 1400 may be configured to generate output corresponding to piezo film strip output. For example, FIG. 14B illustrates an equivalent circuit 1410. The equivalent circuit 1410 may include a first voltage amplifier 1412 configured to generate a first output corresponding to the first piezo film strip output 1204 of FIG. 12A, and a second voltage amplifier 1414 configured to generate a second output corresponding to the second piezo film strip output 1206 of FIG. 12A. The first output and the second output may be electrically connected to a voltage amplifier.

When a longitudinal vibration occurs to the impact sensing object and thus subsequently to the piezo film sensor assembly, the first output and the second output may generate the same, or approximately the same amplitude voltage but the first output and the second output may have opposite polarities as the neutral axis is in the middle of the center plate. As the first output and the second output are connected to each other, the first output and the second output may cancel out and the output of the voltage amplifier may be substantially zero.

FIG. 14C illustrates an equivalent circuit 1420. The equivalent circuit 1420 may 1420 may include a first voltage amplifier 1422 configured to generate a first output corresponding to the first piezo film strip output 1224 of FIG. 12B, and a second voltage amplifier 1424 configured to generate a second output corresponding to the second piezo film strip output 1226 of FIG. 12B. The first output and the second output may be electrically connected to a voltage amplifier.

When an impact occurs to the impact sensing object, the first output and the second output may generate the same polarity voltage signals but different amplitudes. As piezo film strips corresponding to the second output are stretched more than the piezo film strips corresponding to the first output, the second output may have a higher amplitude signal than the first output. The higher amplitude signal may be detected through a voltage amplifier.

Therefore, the longitudinal vibration noise may be cancelled and the higher output signal from the four piezo film strips may be detected as the impact signal. The cancelling of the longitudinal vibration noise and the higher output impact signal from the four piezo film strips may increase the signal-to-noise ratio.

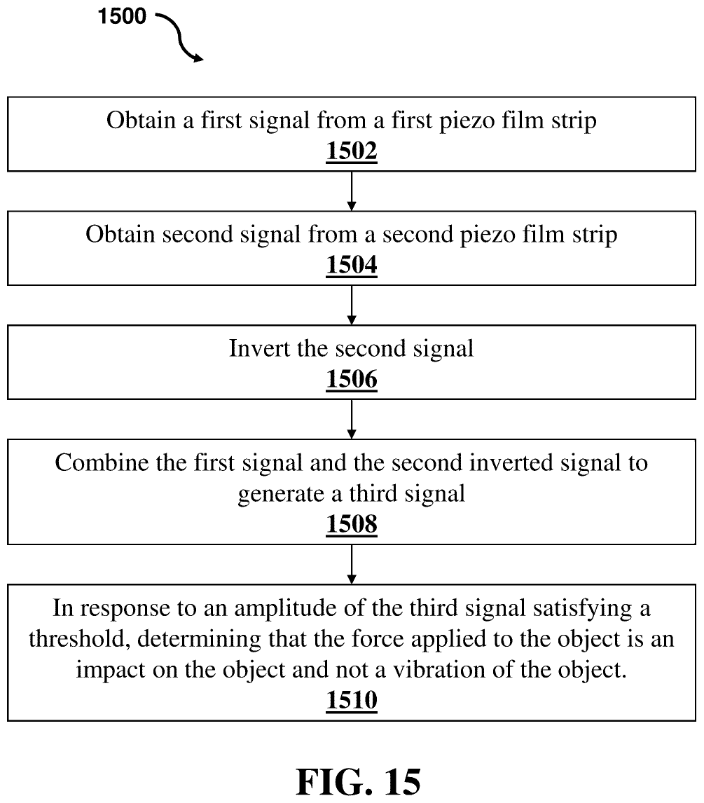

FIG. 15 illustrates a flowchart of an example method 1500 of operation of an impact sensor, arranged in accordance with at least one embodiment of the present disclosure. The method 1500 may be implemented by any suitable system such as impact sensor described herein. Although illustrated as discrete steps, various steps of the method 1500 may be divided into additional steps, combined into fewer steps, or eliminated, depending on the desired implementation. Additionally, the order of performance of the different steps may vary depending on the desired implementation.

The method may begin at block 1502, where a first signal from a first piezo film strip may be obtained. The first piezo film strip may generate the first signal. The first piezo film strip may generate the first signal based on a force applied to an object coupled to the first piezo film strip.

At block 1504, a second signal from a second piezo film strip may be obtained. The second piezo film strip may generate the second signal. The second piezo film strip may generate the second signal based on the same force applied to the object that is also coupled to the second piezo film strip. The second piezo film strip may be coupled to the first piezo film strip via a center plate. The first and second piezo film strips may be part of a sensor assembly that is coupled to the object.

At block 1506, the second signal may be inverted. For example, an inverter may invert the second signal. The

At block 1508, the first signal and the second inverted signal may be combined to generate a third signal. The first signal and the second inverted signal may be combined by a differential amplifier.

At block 5110, in response to an amplitude of the third signal satisfying a threshold, it may be determined that the force applied to the object is an impact on the object and not a vibration of the object. The impact of the object may be a force applied at a normal or substantially a normal of the surface of the object. An impact may be single force applied in a single direction on the object while a vibration may cause oscillation of the object. The threshold may be based on the configuration of the first and second piezo film strips, the configuration of a sensor assembly that includes the first and second piezo film strips, and/or the interface circuitry.

Modifications, additions, or omissions may be made to the method 1500 without departing from the scope of the present disclosure. For example, the outlined steps and operations are only provided as examples, and some of the steps and operations may be optional, combined into fewer steps and operations, or expanded into additional steps and operations without detracting from the essence of the disclosed embodiments.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. An impact detector, comprising:
a sensor mounting bracket attached to an impact sensing object;
a piezo film sensor assembly coupled to the sensor mounting bracket; and
an interface circuit to obtain one or more generated signals from the piezo film sensor assembly, the interface circuit configured to reduce a first amplitude associated with a noise signal of the one or more generated signals and amplify a second amplitude associated with an impact signal of the one or more generated signals, where the impact signal occurs in response to a force being applied to the impact sensing object.

2. The impact detector of claim 1, wherein the piezo film sensor assembly further comprises:
at least four piezo film strip sensors; and
a center plate, wherein:
a first set of piezo film strip sensors of the at least four piezo film strip sensors are disposed on a first side of the center plate;
a second set of piezo film strip sensors of the at least four piezo film strip sensors are disposed on a second side of the center plate, opposite the first side; and
the first set of piezo film strip sensors and the second set of piezo film strip sensors are positioned symmetrically across the center plate.

3. The impact detector of claim 2, further comprising one or more foam layers attached to the at least four piezo film strip sensors.

4. The impact detector of claim 1, wherein the piezo film sensor assembly further comprises:
a first piezo film strip sensor;
a second piezo film strip sensor; and
a center plate, wherein:
the first piezo film strip sensor is disposed on a first side of the center plate;
the second piezo film strip sensor is disposed on a second side of the center plate, opposite the first side; and
the first piezo film strip sensor and the second piezo film strip sensor are positioned symmetrically across the center plate.

5. The impact detector of claim 4, further comprising a first foam layer attached to the first piezo film strip sensor and a second foam layer attached to the second piezo film strip sensor.

6. The impact detector of claim 5, further comprising a gap between a first surface of the first foam layer and other surfaces of the impact detector.

7. The impact detector of claim 1, wherein the piezo film sensor assembly is coupled to the sensor mounting bracket such that the piezo film sensor assembly has freedom of movement in a least one axis in a three-dimensional plane.

8. The impact detector of claim 1, wherein the piezo film sensor assembly is coupled to the sensor mounting bracket such that an air gap exist between the piezo film sensor assembly and the sensor mounting bracket.

9. The impact detector of claim 1, wherein the housing includes a locking mechanism that provides water resistant protection to the piezo film sensor assembly.

10. The impact detector of claim 1, wherein the interface circuit comprises:
an inverting voltage amplifier;
a non-inverting voltage amplifier; and
a differential amplifier, wherein:
the inverting voltage amplifier obtains one or more signals from a first set of piezo film strip sensors to produce a first output;
the non-inverting voltage amplifier obtains one or more signals from a second set of piezo film strips sensors to produce a second output; and
the differential amplifier obtains the first output and the second output.
